(19) United States
(12) Patent Application Publication
(10) Pub. No.: US 2010/0031352 A1
(43) Pub. Date: Feb. 4, 2010

(54) System and Method for Enforcing Licenses During Push Install of Software to Target Computers in a Networked Computer Environment

(76) Inventor: AMARENDER REDDY KETHIREDDY, Corona, CA (US)

Correspondence Address: MICHAEL BLAINE BROOKS, PC, P.O. BOX 1630, SIMI VALLEY, CA, 93062-1630, US

(21) Appl. No.: 12/185,686

(22) Filed: Aug. 4, 2008

(51) Int. Cl. G06F 12/14; G06Q 10/00

(52) U.S. Cl. 726/21; 705/7

(57) ABSTRACT

Systems, methods, and computer-readable media for enforcing licenses during the push install of a software package in a networked environment via parsed serial numbers.

### FIELD OF ENDEAVOR

The present invention in its several embodiments relates generally to license enforcement in a networked environment, and more particularly to systems and methods of enforcing licenses during push installation of a software package in a networked environment.

### BACKGROUND

In a computer networked environment, a central server manages the workstations, or computing nodes, within a specific domain. FIG. 1 is an exemplary prior art diagram of a network system 100 comprising a network server 130 that is in communication with a plurality of networked devices 131, 132, 133 within the domain via one or more network segments 140 which may be cables or wireless segments and may include, edge, routing, and/or switching devices. Also illustrated in FIG. 1 is a license validation server 120 outside of the instant domain which may be accessed via a communication medium 150, such as the internet in order to validate a licensed installation for a particular file of a particular vendor.

In a network environment based on an operating system such as MICROSOFT™ WINDOWS™, ACTIVE DIRECTORY™ is used as a directory service for storing information about network resources across a domain in a structure that provides a hierarchical framework of objects for centralized administration of such objects as users and computers. Software distributions within the network may be handled typically by another service. So, while ACTIVE DIRECTORY™ does not automate software distribution, it may provide a process by which other services may provide software distribution.

In the MICROSOFT™ WINDOWS™ environment, “push install” is understood to refer to a process where a software package is configured on the server and that software package is installed in a fashion generally unattended by a human administrator. Push install of a software package may be achieved by publishing an installation package, e.g., a MICROSOFT™ WINDOWS™ installer (MSI) package, using the ACTIVE DIRECTORY™ group policies in a MICROSOFT™ WINDOWS™ ACTIVE DIRECTORY™ networked environment. In addition, push install typically is used to push security updates, policies onto the client machines from the centralized server.

Accordingly, “push” may be understood in this field of endeavor to refer to a process that a server uses to install software, automatically and in what may be termed a silent mode, at one or more configured target machines that comprise the network. Typically, the system administrator configures a push installation package on the server and assigns the target machines in the network controlled by that server, and thereafter the target machines are rebooted to complete the installation in silent mode. Typically, no validation steps at the time of pushing are performed to confirm that the pushed software is properly licensed. Rather, the software that is the subject of the push installation will be installed on all the configured clients. In some scenarios, an evaluation serial key will be incorporated with the pushed software the evaluation key is typically valid for a defined evaluation period. A common process for the validation of each installed software license includes, an active internet connection originating from the client machine, and communicating a live license validation server of the software manufacturer/provider. In other scenarios, prior to the push installation a sufficient number of licenses are purchased upfront to cover the target machines, and so no validation or enforcement need be done at the time of the push installation.

Typically, software installations require inputting a serial number in order to track the licenses for that software. Serial numbers for installation purposes typically represent a unique number associated with each copy of the licensed software. The digits of the serial number, when taken together, are not necessary selected to communicate a meaning other than that of being a unique number to facilitate validation of the installation of a duly licensed software package. The validation/activation of the license may be accomplished in real-time against the license validation server from the software provider. In an environment where an internet connection is not available, other modes of validation may be used to validate the license, such as via a telephone or a FAX communication. In scenarios of software package installations where there is no live license server, there is no server-based way to enforce the number of licenses during the push install of the software package. In this type of scenario, the serial number is valid typically for just one installation.

The validation/activation of the license may be accomplished in real-time against the license validation server from the software provider. In an environment where an internet connection is not available, other modes of validation may be used to validate the license, such as via a telephone or a FAX communication. In scenarios of software package installations where there is no live license server, there is no server-based way to enforce the number of licenses during the push install of the software package. In this type of scenario, the serial number is valid typically for just one installation.

### SUMMARY

This disclosure outlines the system and method for enforcing licenses during the push install of a software package in a networked environment. While embodiments described herein, by example, are making reference to MICROSOFT™ WINDOWS™ ACTIVE DIRECTORY™, embodiments of the present inventions may be enabled in other client-server environments having other operating systems and directories supportive of push installation.

Embodiments of the present invention include a computing device comprising a processing unit and addressable memory where the processing unit may be adapted to execute instructions that include the steps of: (a) parsing a serial number associated with a licensed file; (b) determining a value representing a number of licensed installations of the licensed file based on the parsed serial number; and (c) pushing the licensed file to a quantity of target devices wherein the target device quantity is based on the determined value of licensed installations. The processing unit of the computing device may be further adapted to limit the quantity of target devices based on the determined value of licensed installations via a configuration file.

Embodiments of the present invention also include a computer server hosted on a computing device comprising a processing unit and addressable memory, where the computer server comprises: (a) a parsing module for analyzing a string of characters input as a serial number associated with a licensed file; (b) a license valuing module for determining a value representing a number of licensed installations of the licensed file based on the parsed serial number; and (c) a pushing module for preparing for transmission to a quantity of target clients, each target client hosted on a respective computing device comprising a processing unit and addressable memory, wherein the target client quantity is based on the determined value of licensed installations. The pushing module of the computer server may be further adapted to limit the quantity of target clients based on the determined value of licensed installations via a configuration file.

Embodiments of the present invention may include a machine-enabled method of installing a licensed file from a server to a set of clients in a computer network, the set of clients having one or more members, the method comprising the steps of: (a) parsing a serial number associated with a licensed file; (b) determining a value representing a number of licensed installations of the licensed file based on the parsed serial number; and (c) pushing the licensed file to a set of target clients wherein the client member quantity within the set is based on the determined value of licensed installations. The machine-enabled method may further comprise the step of limiting the client member quantity within the set based on the determined value of licensed installations via a configuration file.

Embodiments of the present invention may include a computer-readable medium having computer-executable instructions stored thereon which, when executed by a computer, are operative to cause the computer to perform instructions of: (a) parsing a string of characters input as a serial number associated with a licensed file; (b) determining a value representing a number of licensed installations of the licensed file based on the parsed serial number; and (c) pushing to a quantity of target devices, wherein the target device quantity is based on the determined value of licensed installations. The computer-readable medium may further have computer-executable instructions stored thereon which, when executed by a computer, are operative to cause the computer to limit the target device quantity based on the determined value of licensed installations via a configuration file.

### BRIEF DESCRIPTION OF THE DRAWINGS

Embodiments of the present invention are illustrated by way of example and not limitation in the figures of the accompanying drawings, and in which:

FIG. 1 is an exemplary network diagram;

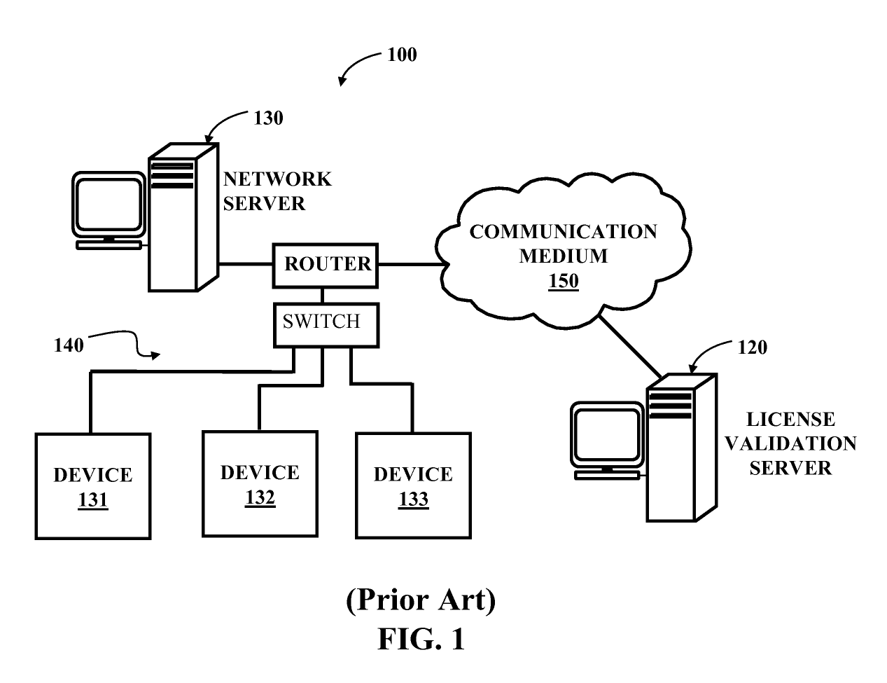

FIG. 2 is an exemplary graphical user interface of the present invention;

FIG. 3 is an exemplary parsed serial number table and legend of the present invention;

FIG. 4A is a top-level flowchart of a portion of a process embodiment of the present invention; and

FIG. 4B is a top-level flowchart of a portion of a process embodiment of the present invention.

### DETAILED DESCRIPTION

In the case of push install, when it is not possible to assign serial numbers to each of the configured target machines, then there is no way to control the software licenses during the push install process. The invention, in its several embodiments, facilitates the enforcement of licenses during the push install of the software without requiring the live license validation server. While configuring the push install on a server, the administrator is provided with a user interface to input the one or more serial numbers associated with the software to be installed. Each serial number for validation is both a unique number and a number constructed via steps that have embedded the number of licenses within the serial number itself. Each of the one or more serial numbers entered during the configuration may be parsed and, from the results of the parsing, the total licenses available may be derived. The total available licenses may be validated against the total target machines configured for the push process and the software may be limited in installation to the target number of machines equaling the total licenses available. If more target machines are configured for push than the available licenses, a warning message may also be issued to the administrator during configuration of, and prior to the client-directed transmission portion, of the push procedure.

Embodiments of the present invention have the number of licenses authorized for software package installation embedded according to particular steps, within the serial number for the software package. Once the embedded number of licenses is extracted from the serial number, the licensing parameters of the licensed number of software packages for installation may be enforced during the push install of software package without requiring a live internet connection on the client side for communicating with a live license validation server.

There may be two components involved in configuring the push install of software on the server for dynamic license validation: (1) the MSI package for the software to be installed; and (2) the config.exe tool. In this example, the MSI package is the actual installer package for the software to be installed by push and has a dependency on the config file, e.g., config.data, to be generated by the config.exe tool.

Config.exe tool is a software application having instructions and parameter values which provides an interface to input serial numbers and has logical instructions to extract the number of licenses from the serial numbers entered using a set of parsing instructions. By executing the parsing steps, the config.exe tool may determine the total licenses for the push installation associated with the one or more parsed serial numbers. The config.exe tool also has logical instruction to get the target computers assigned as an organizational unit (OU) using, for example, the ACTIVE DIRECTORY™ application programming directory (API). Based on the number of target machines configured for push installation and based on the serial numbers entered, the config.exe tool validates the licenses. If the target machines are less than or equal to the total licenses available, the config.exe tool may generate a config file, e.g., config.data that may be used by the MSI package during the installation on the target client machines. The config.exe tool generated file, i.e., config.data, may have information about the target machines configured at the time of generation of the file and the validation of each target machine installation. The config file, i.e., config.data may be a binary file and may also be stabled as unalterable, i.e., it may not be edited. One or more logic steps of the config.exe tool may preclude installation of the MSI package on target machines unless the config.data file is present.

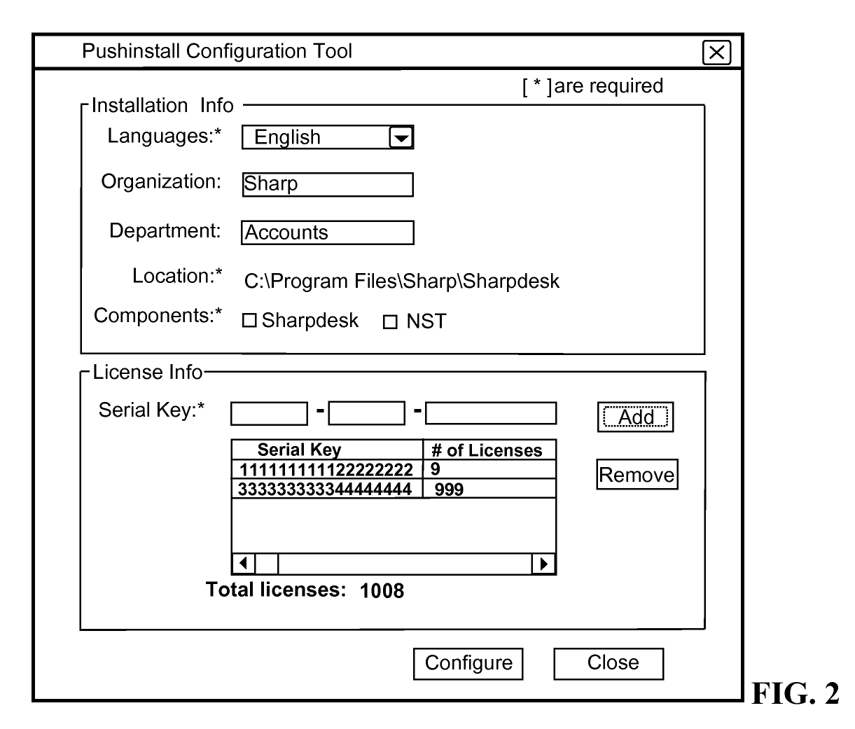

Exemplary server-side configuration steps are detailed using as an example the ACTIVITY DIRECTORY™ and other directories may be used where it is possible to manage all users, computers, and software on the network through administrator-defined policies, that collectively may be referred to as a group policy. A collection of group policy settings may be contained in a group policy object (GPO), and the GPO may be associated with an ACTIVITY DIRECTORY™ container. “Assign to Computers” is an exemplary deployment scenario for pushing the software onto the client target machines. The steps for ACTIVITY DIRECTORY™ configuration may be described according to the following paragraphs where exemplary graphical interface for configuring the serial numbers is shown in FIG. 2.

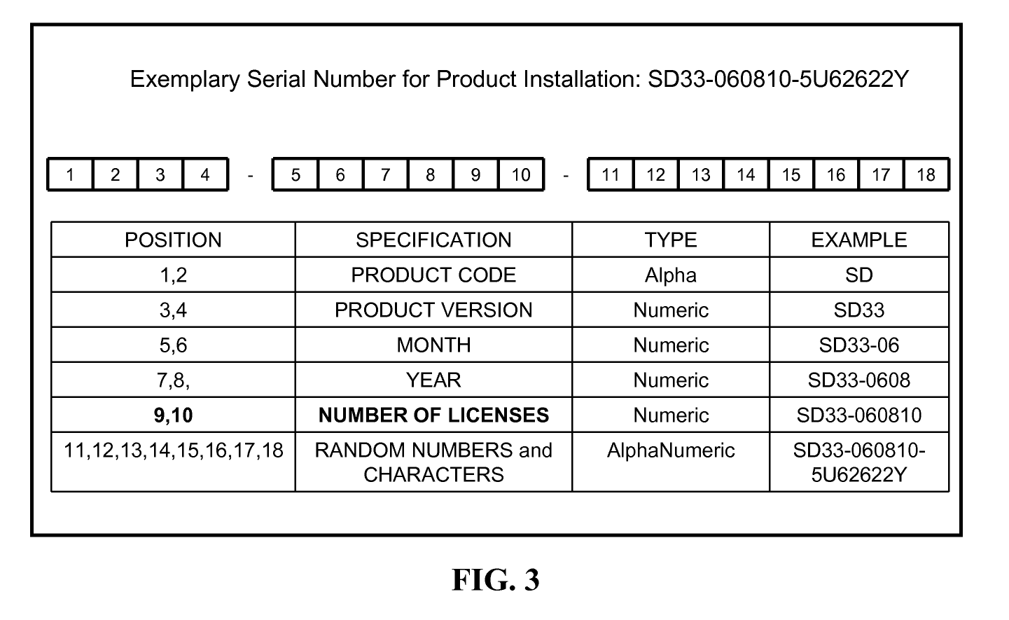

The serial number of the embodiments of the present invention has the number of licensed installation embedded in the serial number itself. While it is contemplated that embodiments of the invention may have serial numbers of various lengths and encryption and decryption may be employed in some embodiments, a human-readable version of an exemplary serial number is explained in detail. An exemplary parsed serial number table and legend of the present invention is shown in FIG. 3. In this example, the licensed file, or product, for installation is assigned a serial number for install shown to have 18 alphanumeric locations or positions. The general identification may be encoded with alphabetical entries in positions 1 and 2. Versions of the general product may be encoded with numeric entries in positions 3 and 4. A product release month may be encoded with numeric entries in positions 5 and 6. A product release year may be encoded in positions 7 and 8. The number of licenses authorized for the installation of the licensed file, or product, may be encoded with numeric entries in positions 9 and 10. Positions 11-18 may be reserved for a randomly generated set of alphanumeric values that are uniquely associated with this particular licensed file, or product. Accordingly, to determine the quantity of licensed installations, embodiments of the present invention parse the serial number to extract positions 9 and 10. So, in this example, it may be determined from the parsed serial number that there are ten licensed installations authorized for the file, or product, associated with this exemplary unique serial number.

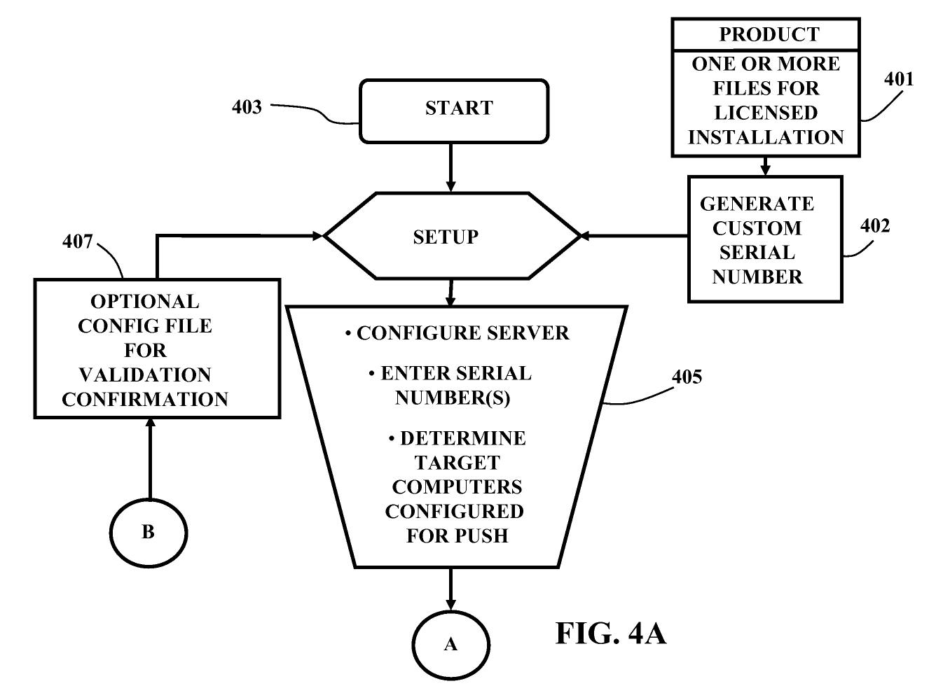

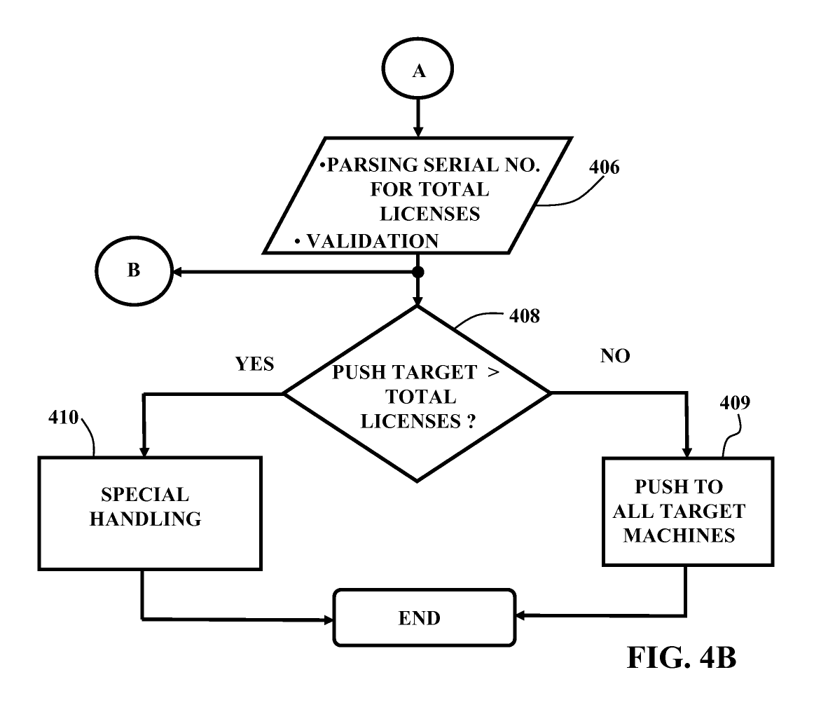

The exemplary top-level flowcharts of FIG. 4A and FIG. 4B, when taken together, illustrate steps for practicing the several embodiments of the present invention. As an overview: to start, 403 a network administrator is provided a product 401 that may be, for example, one or more files for licensed installation within the network. Along with the product is a custom serial number 402 that carries with it the number of authorized installations of the licensed product. The administrator may then configure the server 405 for push installation, determine the target computers to be configured for push installation, and enter the one or more serial numbers associated respectively with the one or more licensed products to be installed via a push installation. Embodiments of the invention cause the server to execute steps to parse 406 the serial number and determine the total number of licenses, i.e., the total number of authorized installations of the licensed product. Optional embodiments of the invention may generate a configuration file 407 that may be used to confirm a push installation having a validated number of licensed products within or at the number of computing machines targeted for the instant push installation. Embodiments of the invention may cause the server to test 408 as to whether the number of target computers configured to receive the push installation is at or within the total number of licenses. If so, the push installation may be allowed to proceed 409. If not, embodiments of the invention may cause the server to address the deficiency via one or more special handling steps 410, such as installing according to a priority list of configured computers or halting, or precluding, the push installation, for example by withholding a particular data file, and signaling to the administrator via, for example, a graphic user interface, that there are insufficient licenses available to proceed with the push installation as instructed.

An exemplary and more particularized set of steps of the invention are as follows:

### Creating the Distribution Package

To deploy using ACTIVITY DIRECTORY™, it is first necessary to create a software distribution point for the MICROSOFT™ WINDOWS™ installer (MSI) application. This step includes sub-steps of creating a shared network folder, as a distribution point folder, on a server or on a distributed file system with appropriate permissions and copying the MSI install image to the created shared network folder and, in accordance with invoked security options, sharing this distribution point folder.

### Creating and Configuring the Organizational Unit

One may create and configure an organizational unit (OU) as a distribution point and populate the OU with target computers. That is, create an ACTIVITY DIRECTORY™ organizational unit which may serve as a software distribution point (e.g., an organization unit) for the MICROSOFT™ WINDOWS™ installer (MSI) and publish the OU to the ACTIVITY DIRECTORY™, along with appropriate access permission levels invoked in accordance with security options. After the distribution point is configured, add the target machines of the domain under the OU for which the software package is to be pushed.

### Creating and Configuring a New Group Policy Object (GPO).

Create and configure a group policy object (GPO) under the organizational unit created above with applicable group policies.

### Adding One or More Serial Numbers to the Distribution Package

Using the license config.exe tool, a user or system administrator may input the one or more serial numbers and other installation information prior to initiating the push install. The config.exe tool provides the interface to enter the serial key, install location path and other data. Based on the serial numbers entered and executing the logical steps of parsing the one or more serial numbers, the total number of licenses are calculated and a configuration file, e.g., config.data, may be generated and may be referenced by the MSI installer.

### Validating and Enforcing Licenses

The config.exe tool comprises one or more logical instructions that extract the number of licenses from the entered serial numbers. The config.exe tool executes the steps of parsing the one or more serial numbers to derive the total licenses for the push installation. The config.exe tool may also comprise logical instructions, that when executed, assign the target computers to an organizational unit (OU) using, for example, an ACTIVITY DIRECTORY™ API. Based on the number of target machines configured for push and based on the entered serial numbers, the config.exe tool validates the licenses. If the target machines are less than or equal to the total licenses available, the config.exe tool may generate a config file, i.e., config.data, that may be referenced by the MSI package during the installation on the target client machines. The config tool generated file, i.e., config.data, contains information about the target machines configured at the time of generation of the file and is validated at each target machine installation. Accordingly, the config.data, may be referenced to ensure that the target machines are not changed after the data file is generated. If the total number of configured machines exceeds the available licenses, the data file, i.e., config.data, may not be generated and without this data file, client installations will fail. That is, one or more logical installation steps, for example in silent mode each of the local target computing machines, may test for the presence of config.data, and preclude the installation of the MSI package if the file is not present. Again, if the total number of configured machines exceeds the available licenses, the config.exe tool may display an error message for the administrator.

While the forgoing embodiments of the present invention may be embodied in any network that support the installation of licensed content via push, the typical implementation environment of an embodiment of the present invention is via a WIN 2003 server within a MICROSOFT™ WINDOWS™, ACTIVE DIRECTORY™ network where the ACTIVE DIRECTORY™ has already been set-up and the domain having target machines has already been set-up and fully operational. Accordingly, the preferred client is one or more target machines, in the domain that may be comprised of several computing devices or nodes, having as an operating system a version of MICROSOFT™ WINDOWS™.

Based on the foregoing, it should be appreciated that provided herein are systems, methods, and computer-readable media for executing the push installation of a licensed file in a network of computing devices based the number of licensed installations determined from a parsed serial number associated with the licensed file. One of ordinary skill in the art will also appreciate that the modules and functions described herein may be further subdivided, combined, and/or varied and yet still be in the spirit of the embodiments of the invention. In addition, while a number of variations of the invention have been shown and described in detail, other modifications, which are within the scope of this invention, will be readily apparent to those of ordinary skill in the art based upon this disclosure, e.g., the exemplary flowcharts or processes described herein may be modified and varied and yet still be in the spirit of the invention. It is also contemplated that various combinations or subcombinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above.

What is claimed is:

1. A computing device comprising:
a processing unit and addressable memory;
wherein the processing unit is adapted to execute instructions comprising:
parsing a serial number associated with a licensed file;
determining a value representing a number of licensed installations of the licensed file based on the parsed serial number; and
pushing the licensed file to a quantity of target devices wherein the target device quantity is based on the determined value of licensed installations.

2. The computing device of claim 1 wherein the processing unit is further adapted to limit the quantity of target devices based on the determined value of licensed installations via a configuration file.

3. A computer server hosted on a computing device comprising a processing unit and addressable memory, the computer server comprising:
a parsing module for analyzing a string of characters input as a serial number associated with a licensed file;
a license valuing module for determining a value representing a number of licensed installations of the licensed file based on the parsed serial number; and
a pushing module for preparing for transmission to a quantity of target clients, each target client hosted on a respective computing device comprising a processing unit and addressable memory, wherein the target client quantity is based on the determined value of licensed installations.

4. The computer server of claim 3 wherein the pushing module is adapted to limit the quantity of target clients based on the determined value of licensed installations via a configuration file.

5. A machine-enabled method of installing a licensed file from a server to a set of clients in a computer network, the set of clients having one or more members, the method comprising:
parsing a serial number associated with a licensed file;
determining a value representing a number of licensed installations of the licensed file based on the parsed serial number; and
pushing the licensed file to a set of target clients wherein the client member quantity within the set is based on the determined value of licensed installations.

6. The machine-enabled method of claim 1 further comprising the step of limiting the client member quantity within the set based on the determined value of licensed installations via a configuration file.

7. A computer-readable medium having computer-executable instructions stored thereon which, when executed by a computer, are operative to cause the computer to:
perform one or more instructions of:
parsing a string of characters input as a serial number associated with a licensed file;
determining a value representing a number of licensed installations of the licensed file based on the parsed serial number; and
pushing to a quantity of target devices, wherein the target device quantity is based on the determined value of licensed installations.

8. The computer-readable medium of claim 7 further having computer-executable instructions stored thereon which, when executed by a computer, are operative to cause the computer to limit the target device quantity based on the determined value of licensed installations via a configuration file.
